(19) United States
(12) Patent Application Publication
(10) Pub. No.: US 2015/0215038 A1
(43) Pub. Date: Jul. 30, 2015

(54) System and Method for Pilot Tone Modulation by Data Bias

(71) Applicant: FutureWei Technologies, Inc., Plano, TX (US)

(72) Inventors: Zhiping Jiang, Kanata (CA); Jian Zhong, Kanata (CA)

(73) Assignee: FutureWei Technologies, Inc., Plano, TX (US)

(21) Appl. No.: 14/167,359

(22) Filed: Jan. 29, 2014

(51) Int. Cl. H04B 10/079; H04J 14/02; H04Q 11/00; H04B 10/54; H04B 10/60

(52) U.S. Cl. CPC H04B 10/07955; H04B 10/541; H04B 10/60; H04Q 11/0066; H04J 14/0227; H04Q 2011/0083

(57) ABSTRACT

Embodiments are provided for applying pilot tone modulations to optical signals by introducing bias bits to data frames carried on the optical signals. Since the modulation is done by modifying data, the modulation depth is accurate, and there is no need for calibration or feedback control, which can improve power monitoring accuracy and simplify implementation. In an embodiment, a transmitter determines a period of a pilot tone modulation for tracking or identifying an optical channel. The transmitter inserts a sequence of bias bits, periodically according to the determined period, in a plurality of frames comprising original data bits. The amplitudes of the optical signals carrying the frames are modulated at a higher frequency than the pilot tone modulation. The optical signals are then transmitted including the bias bits within the frames.

### TECHNICAL FIELD

The present invention relates to the field of optical communications, and, in particular embodiments, to a system and method for pilot tone modulation by data bias.

### BACKGROUND

In optical systems such as dense wavelength division multiplexing (DWDM) systems, low frequency modulation in the form of pilot tone modulations can be applied to a channel to carry its wavelength and other identification information, which improves fiber link management and facilitates power monitoring. The low modulations are usually added internally via a data driver by modulating its driving amplitude, or externally via variable optical attenuators (VOAs). Modulations added through data drivers require additional hardware and hence cost. The driver also requires feedback control and calibration, increasing system complexity. Modulations added through external VOAs also increase cost and cause difficulty for achieving higher frequency modulation. There is a need for an efficient pilot tone modulation scheme that overcomes such issues.

### SUMMARY OF THE INVENTION

In accordance with an embodiment of the disclosure, a method by a transmitter for low optical frequency modulation includes determining a period of a pilot tone modulation for tracking an optical channel. A sequence of bias bits is then inserted, periodically according to the determined period, in a plurality of frames comprising original data bits. The amplitudes of optical signals carrying the frames are then modulated at a higher frequency than the pilot tone modulation. The method further includes transmitting, in an optical fiber, the optical signals including the bias bits within the frames.

In accordance with another embodiment of the disclosure, a method by a receiver for receiving frames including bias bits for pilot tone modulation includes receiving a plurality of frames carried on optical signals in an optical fiber. Each of the optical signals has a respective low frequency according to a pilot tone modulation. The frames include bias bits providing the pilot tone modulation. The method further includes removing the bias bits from the frames, and detecting original data bits in the frames after removing the bias bits.

In accordance with another embodiment of the disclosure, a transmitter for low optical frequency modulation includes at least one processor and a non-transitory computer readable storage medium storing programming for execution by the at least one processor. The programming includes instructions to determine a period for a pilot tone modulation for tracking an optical channel. The programming includes further instructions to insert a sequence of bias bits, periodically according to the determined period, in a plurality of frames comprising original data bits. The programming further configures the transmitter to modulate amplitudes of optical signals carrying the frames at a higher frequency than the pilot tone modulation, and then transmit, in an optical fiber, the optical signals including the bias bits within the frames.

In accordance with yet another embodiment of the disclosure, a receiver for receiving frames including bias bits for pilot tone modulation includes at least one processor and a non-transitory computer readable storage medium storing programming for execution by the at least one processor. The programming includes instructions to receive a plurality of frames carried on optical signals in an optical fiber, where each of the optical signals has a respective low frequency according to a pilot tone modulation. The frames also include bias bits providing the pilot tone modulation. The programming further configures the receiver to remove the bias bits from the frames, and detect original data bits in the frames after removing the bias bits.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an example of a wavelength division multiplexing (WDM) optical communications system;

FIG. 2 illustrates an embodiment of a pattern design for pilot tone modulation by data bias;

FIG. 3 illustrates an embodiment of a system for pilot tone modulation by data bias;

FIG. 4 illustrates an embodiment of determining a sequence of bias bits corresponding to a desired pilot tone modulation;

FIG. 5 illustrates an embodiment of a method for pilot tone modulation by data bias;

FIG. 6 illustrates an embodiment of a method for receiving frames including bias bits for pilot tone modulation;

FIG. 7 illustrates another embodiment of a method for pilot tone detection; and

FIG. 8 is a diagram of a processing system that can be used to implement various embodiments.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Embodiments are provided herein for applying pilot tone modulations to optical signals, such as high baud rate signals, via data bias. The pilot tone modulations can carry the channel identification information of the optical signal and can also collect the channel information as the signal propagates down the fiber link. The pilot tone modulation scheme herein has relatively lower cost than other techniques. It may require a new chip design as a one-time investment. Since the modulation is done by modifying data, the modulation depth is accurate, and there is no need for calibration/feedback control, which can improve power monitoring accuracy and simplify implementation.

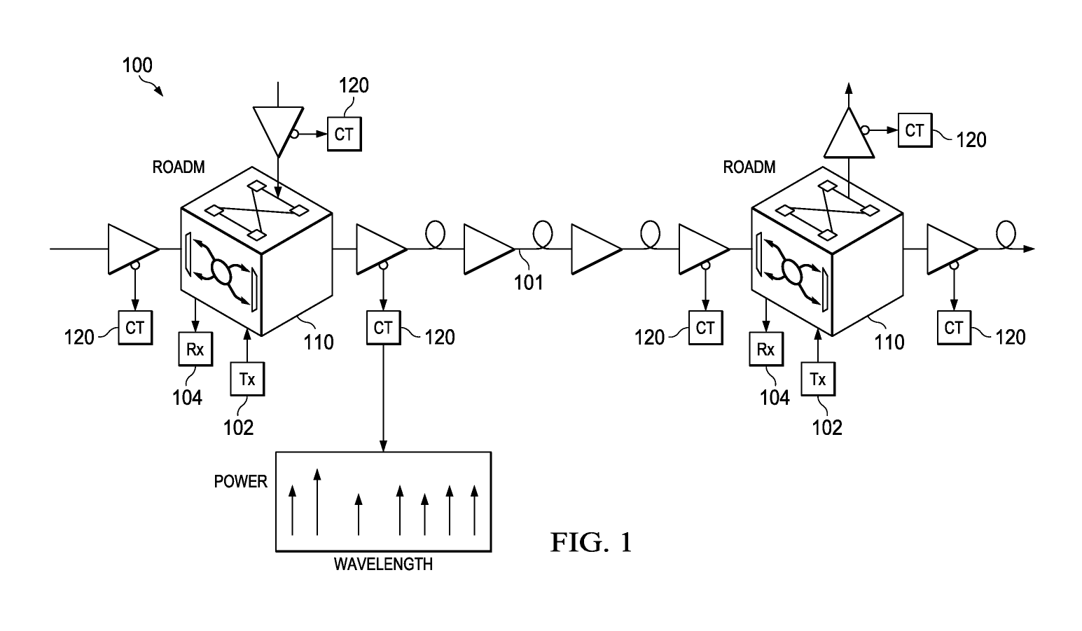

FIG. 1 shows an example of a WDM, or dense WDM (DWDM), optical communications system 100. The system 100 includes reconfigurable optical add-drop multiplexers (ROADMs) 110 connected to each other via optical fiber links 101. The ROADMs 110 are coupled (e.g., via fibers) to transmitters 102 (Tx) and receivers 104 (Rx) of optical signals. The ROADM 110 switches WDM traffic at the wavelength layer. Specifically, the ROADM 110 comprises an optical add-drop multiplexer that performs wavelength selective switching. This allows individual or multiple wavelengths carrying data channels to be added and/or dropped from a transport fiber without the need to convert the signals on all of the WDM channels to electronic signals and back again to optical signals.

Additionally, a pilot tone (PT) detector 120 can be tapped anywhere into fiber links 101, e.g., between ROADMs 110 or between a Tx 102 and corresponding Rx 104. The PT detector 120 performs power measurement and/or wavelength identification of optical signals passing through the fiber links 101 using the pilot tone modulation. In an embodiment, the PT detector 120 can be placed at various point of the fiber links (e.g., between the ROADMs 110) to detect and process the pilot tone modulations provided in the optical signals via data bias. The data bias can be added by a framer (not shown) before modulating the optical signals by an optical modulator of the transmitters 102. The details of applying and detecting this pilot tone modulation are described below.

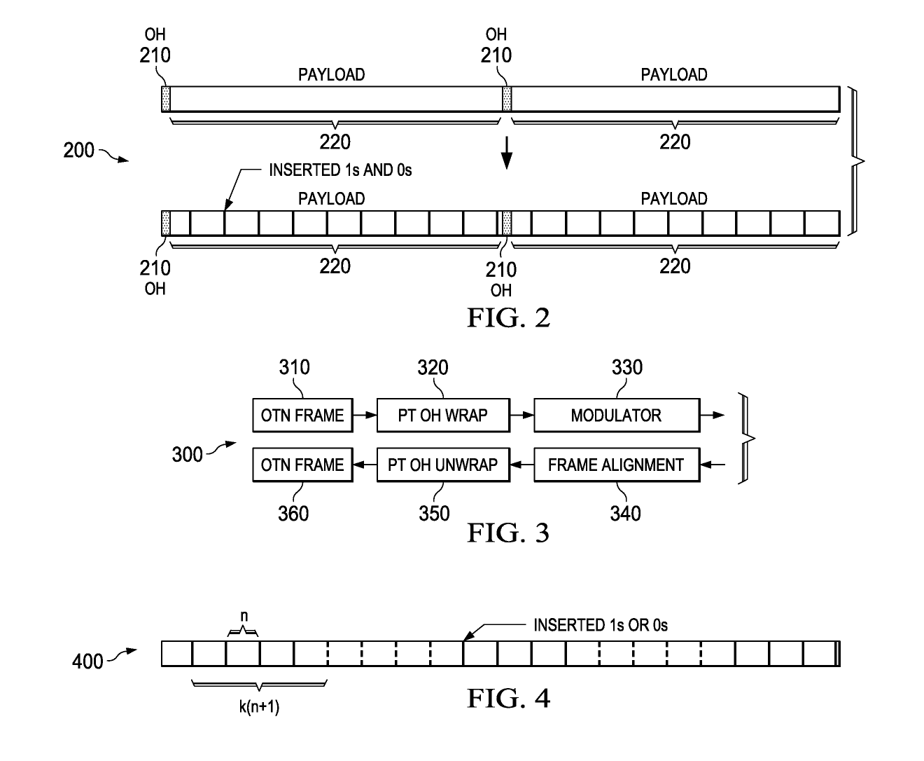

FIG. 2 illustrates an embodiment of a bit pattern design 200 for pilot tone modulation by data bias, which can be used in the system 100. A transmitted data stream (by a transmitter 102) is shown before and after applying the pilot tone modulation via data bias. Before the pilot tone modulation, the data stream includes payloads 220 and optionally a header (labeled OH) 210 that precedes the payloads 220. The data stream, including payloads 220 and OH 210, is modulated (by the optical modulator of the transmitter 102) at a relatively high modulation or baud rate according to the WDM or DWDM system requirements. The data stream can be any continuous data stream, for example including Optical Transport Network (OTN)/Optical channel Transport Unit (OTU) frames. To add the pilot tone modulation in the stream, bias bits (e.g., a sequence of 1/0 bits) are inserted (e.g., by the Tx framer) in the stream at desired periodic intervals that determine the pilot tone modulation. The modulation frequency is determined by the location of the inserted bias 1/0 bits. The modulation depth is determined by the ratio of the inserted 1s/0s over the original data (in payload 220/header 210). Since the added 1s/0s for pilot tone modulation reduce the actual data rate (payload rate), over-clocking may be used to maintain the data rate.

FIG. 3 illustrates an embodiment of a system 300 for pilot tone modulation by data bias. The system 300 includes functions blocks or modules at a transmitter, e.g., at the Tx 102, and corresponding functions blocks/modules at a receiver, e.g., at the Rx 104. The functions blocks/modules may be implemented using software, hardware, or both. The functions blocks/modules at the transmitter include an OTN frame function 310, a PT OH wrap function 320, and an optical modulator 330. The OTN frame function 310 configures and generates the OTN frame in the stream, including the payload and header. The PT OH wrap function 320 inserts the bias bits (e.g., 1s/0s) for pilot tone modulation as described above to the stream. The OTN frame (payload and header) is wrapped with the bias bits before being sent to drive the optical modulator 330 for modulating and sending optical signals in fiber links The bias bits represent PT overhead inserted into fixed locations inside the OTN frame stream (within or between OTN frames) from the OTN frame function 310. For example, one PT bit is inserted after every 48 OTN bits, resulting in about 2% PT overhead. The optical modulator 330 then modulates the optical amplitude of the data for transmission.

The functions blocks/modules at the receiver include a frame alignment function 340, a PT OH unwrap function 350, and an OTN frame processing function 360. The frame alignment function 340 aligns the incoming frames properly. This includes identifying and separating each frame in the stream. The frames with PT OH comprising the bias bits are first aligned. The PT OH unwrap function 350 then removes the PT overhead (bias bits) from the frames. The location and amount of this PT overhead can vary according to implementation. The remaining payload/header is passed to the OTN frame processing function 360 for processing the actual data. The PT OH unwrap function 350 is needed in the receiver in order for the receiver to work properly (remove the bias bits). However, the detection of the bias bits for determining the pilot tone modulation is carried by a PT detector positioned anywhere suitable on fiber links (e.g., the PT detector 120).

FIG. 4 illustrates an embodiment of a scheme 400 for determining a sequence of bias bits corresponding to a desired pilot tone modulation. The sequence of bias bits includes a total number of k bias bits, where k is an integer. Further, the bits within the sequence are separated by a spacing of n bits, where n is an integer. The sequence is repeated periodically in the frames (as shown) with a period equal to k×n. To keep the same data rate in the stream as prior to inserting the bias bits, the baud rate is increased from the original baud rate R to R×(n+1)/n. The modulation frequency is fₖ=R/(2kn). For example, given R=10.709 GHz, n=48, and fₖ=111.55/k MHz, the baud rate is increased by 1/48 or 2.08%, and the modulation depth is 1/48 or 2.08%. For k ranging from 100 to 200, fₖ ranges from 1.1155 MHz to 0.55776 MHz. The bias bits are used according to the scheme 400 for providing a pilot tone modulation for a given channel. Similarly, one or more additional sequence of bias bits can be used to provide one or more additional pilot tone modulations for one or more additional channels, respectively.

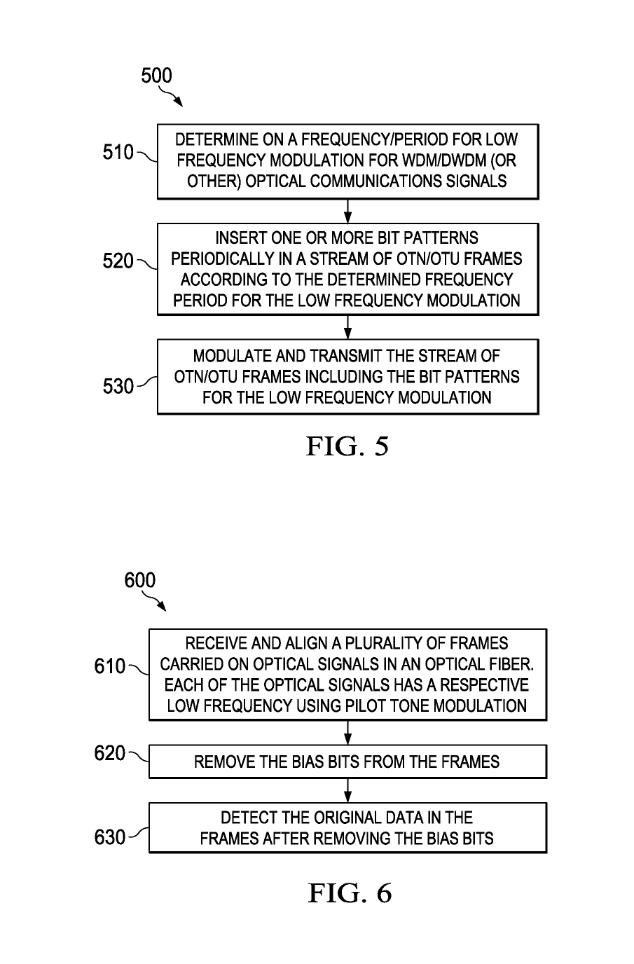

FIG. 5 illustrates an embodiment of a method 500 for pilot tone modulation by data bias. The method 500 is implemented at a transmitter end. At step 510, a frequency/period for pilot tone modulation is determined for WDM/DWDM (or other) optical communications signals. At step 520, one or more bit patterns are inserted periodically in a stream of OTN/OTU frames according to the determined frequency period for the pilot tone modulation. At step 530, the stream of OTN/OTU frames including the bit patterns for the pilot tone modulation is modulated and transmitted.

FIG. 6 shows an embodiment of a method 600 for receiving frames including bias bits for pilot tone modulation. The method is implemented at a receiver end. At step 610, the receiver receives and aligns a plurality of frames carried on optical signals in an optical fiber. Each of the optical signals has a respective low frequency using pilot tone modulation. Specifically, the frames include bias bits providing the pilot tone modulation. At step 620, the bias bits are removed from the frames. At step 630, the original data in the frames is detected after removing the bias bits.

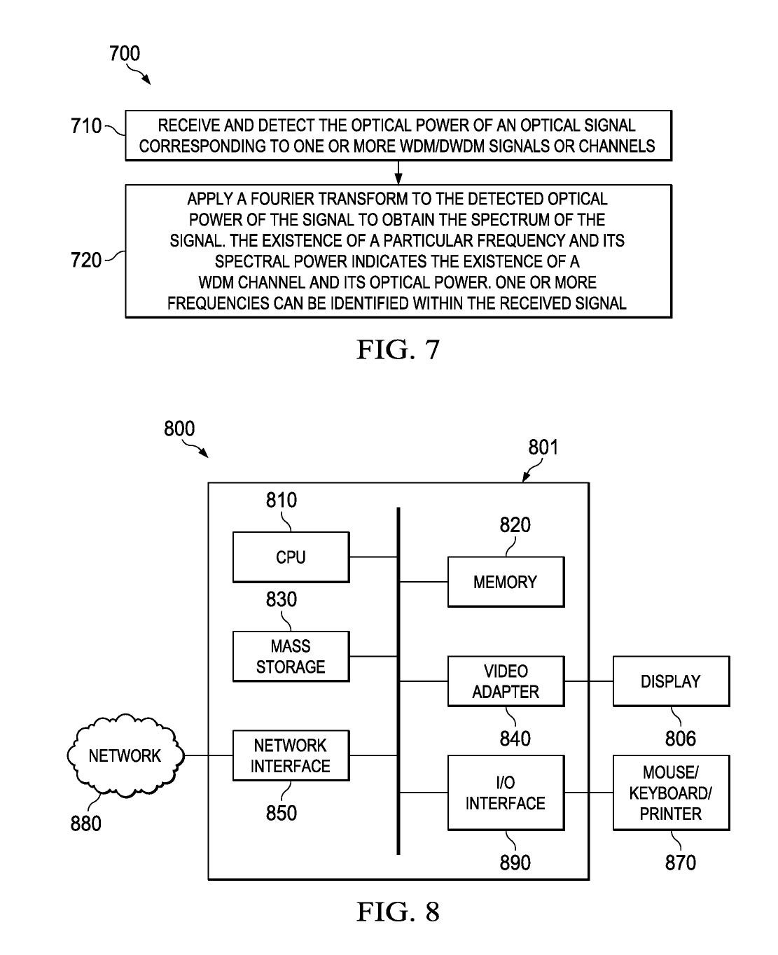

FIG. 7 illustrates another embodiment of a method 700 for detecting pilot tone. The method 700 is implemented by a PT detector or the like, e.g., anywhere in the network to detect the pilot tone introduced in a channel using the method 500. At step 710, a PT detector (e.g., including a photodiode, an electric amplifier circuit, an analog-to-digital converter, and a data processor) receives and detects the optical power of an optical signal corresponding to one or more WDM/DWDM signals or channels. Each channel has a unique low frequency modulation in the form of pilot tone. At step 720, a Fourier transform is applied to the detected optical power of the signal to obtain the spectrum of the signal. The existence of a particular frequency and its spectral power indicates the existence of a WDM channel and its optical power. One or more frequencies can be identified within the received signal. The PT detection does not examine the data frames.

FIG. 8 is a block diagram of an exemplary processing system 800 that can be used to implement various embodiments. The processing system is part of a communications system, such as at the central office or a network component or node (e.g., a router). The processing system 800 may comprise a processing unit 801 equipped with one or more input/output devices, such as a speaker, microphone, mouse, touchscreen, keypad, keyboard, printer, display, and the like. The processing unit 801 may include a central processing unit (CPU) 810, a memory 820, a mass storage device 830, a video adapter 840, and an Input/Output (I/O) interface 890 connected to a bus. The bus may be one or more of any type of several bus architectures including a memory bus or memory controller, a peripheral bus, a video bus, or the like.

The CPU 810 may comprise any type of electronic data processor. The memory 820 may comprise any type of system memory such as static random access memory (SRAM), dynamic random access memory (DRAM), synchronous DRAM (SDRAM), read-only memory (ROM), a combination thereof, or the like. In an embodiment, the memory 820 may include ROM for use at boot-up, and DRAM for program and data storage for use while executing programs. The mass storage device 830 may comprise any type of storage device configured to store data, programs, and other information and to make the data, programs, and other information accessible via the bus. The mass storage device 830 may comprise, for example, one or more of a solid state drive, hard disk drive, a magnetic disk drive, an optical disk drive, or the like.

The video adapter 840 and the I/O interface 890 provide interfaces to couple external input and output devices to the processing unit. As illustrated, examples of input and output devices include a display 860 coupled to the video adapter 840 and any combination of mouse/keyboard/printer 870 coupled to the I/O interface 890. Other devices may be coupled to the processing unit 801, and additional or fewer interface cards may be utilized. For example, a serial interface card (not shown) may be used to provide a serial interface for a printer.

The processing unit 801 also includes one or more network interfaces 850, which may comprise wired links, such as an Ethernet cable or the like, and/or wireless links to access nodes or one or more networks 880. The network interface 850 allows the processing unit 801 to communicate with remote units via the networks 880. For example, the network interface 850 may provide wireless communication via one or more transmitters/transmit antennas and one or more receivers/receive antennas. In an embodiment, the processing unit 801 is coupled to a local-area network or a wide-area network for data processing and communications with remote devices, such as other processing units, the Internet, remote storage facilities, or the like.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method by a transmitter for low optical frequency modulation, the method comprising:
determining a period of a pilot tone modulation for tracking an optical channel;
inserting a sequence of bias bits, periodically according to the determined period, in a plurality of frames comprising original data bits;
modulating amplitudes of optical signals carrying the frames at a higher frequency than the pilot tone modulation; and
transmitting, in an optical fiber, the optical signals including the bias bits within the frames.

2. The method of claim 1 further comprising overclocking transmission of the frames at a higher rate than a desired baud rate for transmitting the original data bits.

3. The method of claim 2, wherein the higher rate compensates for a reduction in transmission rate of original data bits due to inserting the bias bits in the frames.

4. The method of claim 2, wherein the higher rate is equal to a product of the baud rate and a factor related to the period of the sequence of the bias bits.

5. The method of claim 2, wherein the bias bits are separated by a bit-to-bit spacing equal to an integer number of bits, and wherein the period of the sequence of bias bits is equal to a total number of bias bits in the sequence and the bit-to-bit spacing.

6. The method of claim 5, wherein the pilot tone modulation has a frequency equal to the baud rate divided by a product of twice the total number of bias bits in the sequence and the bit-to-bit spacing.

7. The method of claim 1, wherein a ratio of a total number of the bias bits to a total number of the original data bits determines a modulation depth for the pilot tone modulation.

8. The method of claim 1, wherein the inserted bias bits indicate a wavelength of the optical channel and other channel information.

9. The method of claim 1 further comprising:
determining a second period of a second pilot tone modulation for tracking a second optical channel;
inserting a sequence of second bias bits, periodically according to the second period, in a plurality of second frames comprising second original data bits;
modulating amplitudes of second optical signals carrying the second frames at a higher frequency than the second pilot tone modulation; and
transmitting, in the optical fiber, the second optical signals including the second bias bits within the second frames.

10. A method by a receiver for receiving frames including bias bits for pilot tone modulation, the method comprising:
receiving a plurality of frames carried on optical signals in an optical fiber, wherein each of the optical signals has a respective low frequency according to a pilot tone modulation, and wherein the frames include bias bits providing the pilot tone modulation;
removing the bias bits from the frames; and
detecting original data bits in the frames after removing the bias bits.

11. The method of claim 10, wherein the frames including the bias bits are received at a higher rate than a baud rate for the original data bits, and wherein the higher rate allows detecting the original data bits after removing the bias bits at the baud rate.

12. The method of claim 11, wherein the bias bits in the frames are separated by a bit-to-bit spacing equal to an integer number of bits, and wherein a period of a repeated sequence of the bias bits in the frames is equal to a total number of bias bits in the sequence and the bit-to-bit spacing.

13. The method of claim 12, wherein the higher rate exceeds the baud rate by a factor proportional to the bit-to-bit spacing of the bias bits in the sequence.

14. The method of claim 12, wherein the pilot tone modulation is proportional to the baud rate and inversely proportional to the period of the repeated sequence of the bias bits.

15. The method of claim 10, wherein the bias bits are removed after alignment of the received frames.

16. A transmitter for low optical frequency modulation, the transmitter comprising:
at least one processor; and
a non-transitory computer readable storage medium storing programming for execution by the at least one processor, the programming including instructions to:
determine a period for a pilot tone modulation for tracking an optical channel;
inserting a sequence of bias bits, periodically according to the determined period, in a plurality of frames comprising original data bits;
modulate amplitudes of optical signals carrying the frames at a higher frequency than the pilot tone modulation; and
transmit, in an optical fiber, the optical signals including the bias bits within the frames.

17. The transmitter of claim 16, wherein the programming includes further instructions to overclock transmission of the frames at a higher rate than a desired baud rate for transmitting the original data bits, and wherein the higher rate compensates for a reduction in transmission rate of original data bits due to inserting the bias bits in the frames.

18. The transmitter of claim 16, wherein the bias bits are separated by a bit-to-bit spacing equal to an integer number of bits, and wherein the period of the sequence of bias bits is equal to a total number of bias bits in the sequence and the bit-to-bit spacing.

19. The transmitter of claim 16, wherein the optical signals are wavelength division multiplexing (WDM) signals, and wherein the frames are optical transport network (OTN) or optical channel transport unit (OTU) frames.

20. A receiver for receiving frames including bias bits for pilot tone modulation, the receiver comprising:
at least one processor; and
a non-transitory computer readable storage medium storing programming for execution by the at least one processor, the programming including instructions to:
receive a plurality of frames carried on optical signals in an optical fiber, wherein each of the optical signals has a respective low frequency according to a pilot tone modulation, and wherein the frames include bias bits providing the pilot tone modulation;
remove the bias bits from the frames; and
detect original data bits in the frames after removing the bias bits.

21. The receiver of claim 20, wherein the programming includes further instructions to receive the frames, including the bias bits, at a higher rate than a baud rate for the original data bits, and wherein the higher rate allows detecting the original data bits after removing the bias bits at the baud rate.
